(19) United States
(12) Patent Application Publication
(10) Pub. No.: US 2020/0181413 A1
(43) Pub. Date: Jun. 11, 2020

(54) PARTICLES WITH VARIABLE REFRACTIVE INDEX

(71) Applicant: 3M INNOVATIVE PROPERTIES COMPANY, sT. Paul, MN (US)

(72) Inventors: Claire Hartmann-Thompson, Lake Elmo, MN (US); Bill H. Dodge, Finlayson, MN (US); Andrew J. Ouderkirk, Kirkland, WA (US); Christopher S. Lyons, St. Paul, MN (US)

(21) Appl. No.: 16/340,459

(22) PCT Filed: Oct. 5, 2017
(86) PCT No.: PCT/US2017/055295

§ 371 Date: Apr. 9, 2019

Related U.S. Application Data
(60) Provisional application No. 62/409,428, filed on Oct. 18, 2016.

(51) Int. Cl. C09C 1/00; G02B 5/02

(52) U.S. Cl. CPC C09C 1/0021; G02B 5/0242; C01P 2004/88; C09C 2200/1004; C09C 2220/20; C09C 1/0015

(57) ABSTRACT

A particle having a first portion and a second portion surrounding the first portion is described. A volume of the second portion is at least 50 percent of a volume of the particle. The second portion includes a material having a local composition or an effective refractive index that varies substantially continuously across the thickness of the second portion. The material includes a plurality of inorganic regions and may further include organic regions. The particle can be made via atomic or molecular layer deposition.

### BACKGROUND

Particles having a core and a thin shell are known. U.S. Pat. No. 8,865,797 (Matyjaszewski et al.) describe a core-shell composite particle for incorporation into a composite where the composite has improved transparency. The core-shell composite particle includes a core material having a first refractive index and a shell material having a second refractive index. U.S. Pat. No. 8,496,340 (Budd et al.) describes retroreflective elements including a solid spherical core having an outer surface. A first complete concentric optical interference layer overlays the outer surface of the core providing a first interface between the core and the first optical interference layer, and a second complete concentric optical interference layer overlays the first optical interference layer to provide a second interface between the first optical interference layer and the second optical interference layer.

Polymeric particles having multiple layers are known. “Onion-like” multilayered poly(methyl methacrylate (PMMA)/polystyrene (PS) composite particles can be prepared by the solvent-absorbing/releasing method as described in Okubo et al., Colloid Polym. Sci. 279, 513-518 (2001). Particles having a polystyrene core and four alternating layers of polystyrene and poly(trifluoroethyl methacrylate) can be made using a five-stage polymerization series as described in Gourevich et al., Macromolecules 39, 1449-1454 (2006).

### SUMMARY

In some aspects of the present description, a particle having a first portion and a second portion surrounding the first portion is provided where a volume of the second portion is at least 50 percent of a volume of the particle. The second portion includes a material having a composition that varies across a thickness of the second portion and an effective refractive index that varies substantially continuously across the thickness of the second portion. The material in the second portion includes a plurality of inorganic regions.

In some aspects of the present description, a particle having a first portion and a second portion surrounding the first portion is provided where a volume of the second portion is at least 50 percent of a volume of the particle. The second portion includes a material having a local composition that varies substantially continuously across a thickness of the second portion. The material in the second portion includes a plurality of inorganic regions.

In some aspects of the present description, a method of making a particle having a first portion and a second portion surrounding the first portion is provided. The method includes providing the first portion, and growing the particle from the first portion by atomic or molecular layer deposition of a material onto a surface of the growing particle until the particle has an outer diameter at least twice a diameter of the first portion. The material has a composition that varies across a thickness of the second portion and an effective refractive index that varies substantially continuously across the thickness of the second portion.

In some aspects of the present description, a method of making a particle having a first portion and a second portion surrounding the first portion is provided. The method includes providing the first portion, and growing the particle from the first portion by atomic or molecular layer deposition of a material onto a surface of the growing particle until the particle has an outer diameter at least twice a diameter of the first portion. The material has a local composition that varies substantially continuously across a thickness of the second portion.

### BRIEF DESCRIPTION OF THE DRAWINGS

FIG. 1 is a schematic cross-sectional view of a particle;

FIGS. 2-5 are a graphs of effective refractive index as a function of radial coordinate;

FIG. 6 is a schematic cross-sectional view of a particle;

FIG. 7 is a graph of refractive index as a function of radial coordinate;

FIG. 8 is a schematic cross-sectional view of a layer including a plurality of particles;

FIG. 9 is a plot of a light output distribution as a function of scattering angle;

FIG. 10 is a schematic cross-sectional view of a multilayer film having a layer including a plurality of particles;

FIG. 11 is a schematic cross-sectional view of a film or layer disposed on a display;

FIG. 12 is a schematic cross-sectional view of ordered layers of particles;

FIG. 13 is a schematic illustration of a reactor for making particles;

FIG. 14 is a plot of effective refractive index of a particle versus radius;

FIG. 15-16 are plots of weight fractions versus radius; and

FIG. 17 is a plot of effective refractive index of a particle versus radius.

### DETAILED DESCRIPTION

In the following description, reference is made to the accompanying drawings that forms a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

It is sometimes desired to include particles in an adhesive or other polymeric material in order to alter the optical properties of the adhesive or other material. The particles may be chosen to have a suitable refractive index to achieve the desired optical properties. Particles having a thin shell around a core are sometimes used where the shell and the core have differing refractive indices. However, according to the present description it has been found that particles having an effective refractive index that varies substantially continuously through a substantial portion (e.g., at least ½ of the diameter, or at least 50 percent or at least 75 percent of the volume) of the particle can give desired optical properties that are not obtained with conventional core-shell particles. The particles can be used, for example, in scattering control layers, which may or may not include an adhesive or polymeric binder, anti-sparkle films, and the like.

The refractive index at a position in a particle with a varying composition can be determined from the local composition at the position. The local composition at a position refers to the composition of materials in the particle present within some distance of the position where the distance is large compared to the size of a single atom but small compared to a diameter of the particle. This distance can be taken to be 10 nm, 20 nm, 50 nm, or 100 nm, for example. The refractive index determined from the local composition may be referred to as an effective refractive index since this is the quantity that determines the optical properties of the material. The effective permittivity of the local composition can be approximated as the volume weighted average of the relative permittivities of the components in the local composition. The effective refractive index is then the square root of the effective permittivity of the local composition. The effective refractive index can be equivalently described as the square root of the volume weighted average of the squared refractive indices of the components in the local composition. As used herein, the refractive index of a particle refers to the effective refractive index, unless specified otherwise or the context clearly indicates differently. Unless specified differently, refractive index or effective refractive index refers to the refractive index or effective refractive index for light having a wavelength of 589 nm (sodium D line) at 25° C.

An effective refractive index may be said to vary substantially continuously in a portion of the particle if the effective refractive index determined from the local composition at two points in the portion within 20 nm of each other differ by less than 10 percent of a maximum effective refractive index difference in the portion. For example, if the portion of interest is an outer portion of the particle and the effective refractive index has a minimum of 1.4 in this portion and a maximum of 2.0 in this portion, then the effective refractive index varies substantially continuously through this portion of the particle if the difference in effective refractive index determined at any two points in this portion that is within 20 nm of each other is less than 0.06 (0.1 times (2.0-1.4)). In some embodiments, an effective refractive index that varies substantially continuously in a portion of the particle satisfies the condition that the effective refractive index determined from the local composition at any two points within 30 nm of each other, or within 50 nm of each other, differ by less than 10 percent, or by less than 5 percent, or even by less than 2 percent of a maximum effective refractive index difference in the portion. A substantially continuously varying effective refractive index may alternatively be described herein simply as a continuously varying refractive index with the understanding that in the context of a particle having a varying composition, that the refractive index refers to the effective refractive index and that a continuous variation of the refractive index refers to a substantially continuous variation.

In some embodiments, the local composition varies substantially continuously through the second portion of the particle. A local composition may be said to vary substantially continuously in a portion of the particle if the fraction by weight of each component of the local composition present at greater than 10 weight percent at any two points in the portion within 20 nm of each other differ by less than 10 percent of a maximum difference in the fraction by weight of each corresponding component in the portion. In some embodiments, a local composition that varies substantially continuously in a portion of the particle satisfies the condition that the fraction by weight of each component of the local composition present at greater than 10 weight percent, or greater than 5 weight percent, at any two points in the portion within 30 nm of each other, or within 50 nm of each other, differ by less than 10 percent, or less than 5 percent, or even by less than 2 percent of a maximum difference in the fraction by weight of each corresponding component in the portion. A substantially continuously varying local composition may alternatively be described herein simply as a continuously varying composition with the understanding that in the context of a particle having a varying composition, that the composition refers to the local composition and that a continuous variation of the composition refers to a substantially continuous variation.

The particles may be incorporated into a film or an ordered layer or layers of particles may be provided. The film or ordered layer(s) may provide a controlled scattering of light transmitted through the film or ordered layer(s). As described further elsewhere herein, the controlled scattering may provide a light output distribution having a central lobe region, a ring region and a low intensity region separating the central lobe and ring regions. Such light output distributions may be useful in providing an anti-sparkle effect, for example.

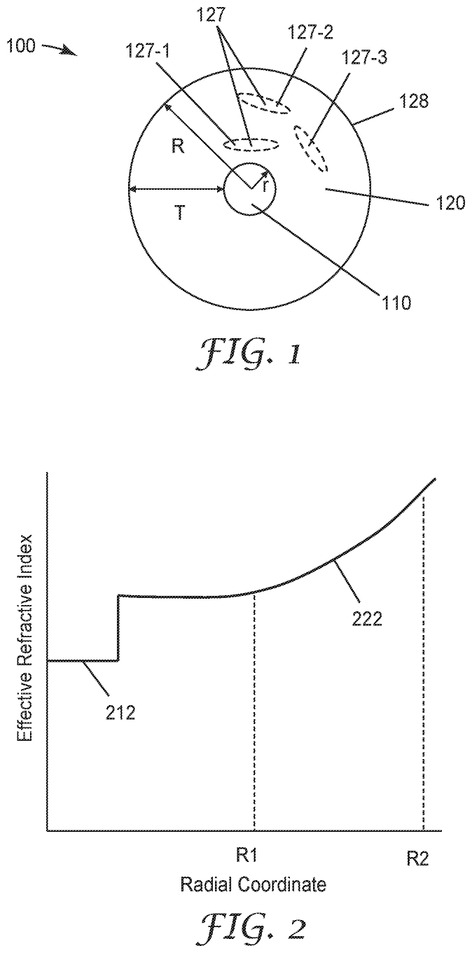

FIG. 1 is a schematic cross-sectional view of particle 100 including first portion 110 and second portion 120 surrounding and enclosing first portion 110. The particle 100 has an outer surface 128 and an outer radius of R, which is also the outer radius of the second portion 120. First portion 110 has an outer radius of r. Particle 100 can be grown by starting with first portion 110, which may be an initially provided homogeneous nanoparticle, for example, and growing the particle by atomic or molecular layer deposition. The particle can be grown using atomic layer deposition (ALD), molecular layer deposition (MLD), or a combination of ALD and MLD, for example. The second portion includes a plurality of regions 127. Three regions 127-1, 127-2, and 127-3 in the plurality of regions 127 are illustrated. In some embodiments, the plurality of regions 127 include a plurality of inorganic regions. For example, region 127-1 may be a first inorganic region and region 127-2 may be a second inorganic region which may have a different composition and refractive index than the first inorganic region. In some embodiments, the first inorganic region 127-1 includes a first inorganic component (e.g., a first metal oxide) and the second inorganic region 127-2 includes a different second inorganic component (e.g., a second metal oxide). In some embodiments, the plurality of regions 127 includes one or more organic regions. For example, region 127-3 may be an organic region. In some embodiments, the plurality of regions 127 include a plurality of inorganic regions and at least one organic region (e.g., a plurality of organic regions).

In some embodiments, the material deposited adjacent the surface of the initial particle may have a composition that matches or substantially matches the composition at the surface of the initial particle so that there may be no physical interface between first portion 110 and second portion 120. In this case, the first portion may refer to a region near a center of a particle having a substantially uniform composition and refractive index and second portion 120 may refer to a portion surrounding first portion 110. In some embodiments, the material deposited adjacent the surface of the initial particle may have a composition different from that of the initial particle, so that a physical interface separates first portion 110 and second portion 120.

The composition of the deposited material may be varied in such that the particle has a substantially continuously varying local composition and a substantially continuously varying effective refractive index across the thickness T of the second portion. In embodiments where the materials deposited adjacent the initial particle (first portion 110) have the same composition as the initial particle, the particle 100 may have a local composition and an effective refractive index that each vary substantially continuously from a center of the particle 100 to an outer surface of the particle 100.

In some embodiments, the particles are grown using a two part/four step ALD reaction/deposition where the first part includes a step of depositing a first precursor followed by a first purge step and the second part includes a step of depositing a second precursor and followed by a second purge step. The particle growth may be performed, for example, using an alternating organometallic precursor charge and an oxidizing charge (oxygen plasma, ozone, water or similar oxidizing agent) with a purge step between each cycle to assure that the precursor do not mix in the gaseous phase. This coating sequence when repeated a given number of times will result in an oxide coating of a given thickness determined by the number of ALD cycles completed and the growth per cycle of the materials used. The effective refractive index of the second portion of the particle is determined by the choice of metal oxide or metal nitride, for example, which is deposited as a result of the organometallic precursor and oxidizing or nitrating precursor, for example, that is chosen.

ALD has been used to coat discrete substrate sheets (U.S. Pat. No. 6,713,177 B2, George et al.), to coat fibrous substrates (U.S. Patent Publication No. 2009/0137043, Parsons et al.), and to coat substrate webs using a continuous roll-to-roll web-handling system (U.S. Patent Publication No. 2010/0189900, Dickey et al.). Particularly useful methods include stepwise atomic layer deposition, as described, for example, in PCT International Publication Nos. WO 2011/037831 (Dodge) and WO 2011/037798 (Dodge), and in U.S. Pat. No. 8,859,040 (Dodge), all of which are hereby incorporated herein by reference to the extent that they do not contradict the present description. Molecular layer deposition or a combination of atomic and molecular layer deposition may also be used as described further in U.S. Pat. Appl. No. 2012/0121932 (George et al.) which is hereby incorporated herein by reference to the extent that it does not contradict the present description. ALD and/or MLD can be carried out in gas phase or in liquid phase. ALD from liquid phase, also known as solution ALD, is described, for example, in Wu et al., Nano Letters 15, 6379-6385 (2015).

The particles may be grown using any type of fluidized bed reactor or rotary/tumbler reactor, for example. Other types of reactors may also be used. Preferably, the reactor keeps the particles moving to prevent agglomeration of the particles and assist in the delivery of the precursors to the surface of the growing particles. In some embodiments, the temperature of the reactor used to grow the particles may be selected based, at least in part, upon the organometallic precursor type, the precursor reactivity and the oxidizer type and oxidizer reactivity. The carrier gas flows can be set to assist in the fluidization of the particles and may be adjusted based on the particle size, particle weight, percent fill and capacity of the reactor and tendency of the particle to agglomerate, for example.

The precursor charge time may be set based on the amount of time needed to totally saturate the available surface area of the particle. This can be determined by observing the presence and concentration of the precursor gases using a Residual Gas Analyzer (RGA). The RGA can also be used to observe the increase and subsequent decrease in the byproducts partial pressure as the particle's surface off gasses during the surface saturation of the particle. By observing the presence of the precursor gases exiting the reactor and the decrease in byproduct gases also exiting the reactor, the RGA can indicate when all of the surface species have been reacted.

The reactor purge gas flow rates and purging times may be set to assure the removal of all excess precursor gases from the reactor system prior to the addition of the next precursor charge. The removal of the precursor gas to its original baseline or to an acceptable level can be determined by observing the concentration of the precursor and byproduct gases using the RGA.

When the particle is grown in an ALD process, the second portion of the particle preferably comprises an inorganic material formed by chemical reaction of the reactive gases. Optionally, the inorganic material comprises at least one oxide of aluminum, silicon, titanium, tin, zinc, or a combination thereof. In some embodiments, ALD is used to deposit a conformal aluminum oxide (Al₂O₃) coating using the binary reaction 2 Al(CH₃)₃+3H₂O→Al₂O₃+6 CH₄. This can be split into the following two surface half-reactions:

AlOH*+Al(CH₃)₃→AlOAl(CH₃)₂*+CH₄ (1)

AlCH₃*+H₂O→AlOH*+CH₄ (2)

In reactions (1) and (2) above, the asterisks denote surface species. In reaction (1), Al(CH₃)₃ reacts with the hydroxyl (OH*) species, depositing aluminum and methylating the surface. Reaction (1) stops after essentially all the hydroxyl species have reacted with Al(CH₃)₃. Then, in reaction (2), H₂O reacts with the AlCH₃* species and deposits oxygen and rehydroxylates the surface. Reaction (2) stops after essentially all the methyl species have reacted with H₂O. Because each reaction is self-limiting, deposition occurs with atomic layer thickness control.

Materials capable of being coated using ALD include binary materials, i.e., materials of the form QₓR_{y}, where Q and R represent different atoms and x and y are selected to provide an electrostatically neutral material. Suitable binary materials include inorganic oxides (such as silicon dioxide and metal oxides such as zirconia, alumina, silica, boron oxide, yttria, zinc oxide, magnesium oxide, titanium dioxide and the like), inorganic nitrides (such as silicon nitride, AlN and BN), inorganic sulfides (such as gallium sulfide, tungsten sulfide and molybdenum sulfide), as well as inorganic phosphides. In addition, various metal coatings are also possible, including cobalt, palladium, platinum, zinc, rhenium, molybdenum, antimony, selenium, thallium, chromium, platinum, ruthenium, iridium, germanium tungsten, and combinations and alloys thereof.

Self-limiting surface reactions can also be used to grow organic polymer regions in the second portion of the particles. This type of growth is often described as molecular layer deposition (MLD), since a molecular fragment is deposited during each reaction cycle. MLD methods have been developed for the growth of polymers such as polyamides, which uses dicarboxylic acid and diamines as reactants. Known approaches to MLD, involving heterobifunctional and ring-opening precursors, can also be used. Further details concerning MLD are described in George et al., Accounts of Chemical Research 42, 498 (2009). In some embodiments, a combination of ALD and MLD is used to deposited both inorganic and organic regions in the second portion of the particles. Utilizing a combination of ALD and MLD techniques to deposit films are described in Lee et al., Advanced Functional Materials 23, 532-546 (2013). An advantage to using a combination of ALD and MLD is that it allows the effective refractive index of the particles to vary substantially continuously over a large range (e.g., 1.4 to 2.35). In some embodiments, a high index component is deposited via ALD and a low index component is deposited by MLD. The organic precursor for the low index component may be an organic diol or polyol, for example, such as ethylene glycol, hexadiyne diol or hydroquinone diol, for example.

Useful discussions of the application of self-limiting sequential coatings can be found, for example, in U.S. Pat. Nos. 6,713,177; 6,913,827; and 6,613,383. Those familiar with the field of ALD reactions can readily determine which first and second reactive gases are appropriate choices for the self-limiting reactions in order to create the coatings discussed above. For example, if an aluminum containing compound is desired, trimethylaluminum or triisobutylaluminum gases may be used as one of the two reactive gases. When the desired aluminum containing compound is aluminum oxide, the other reactive gas in the iterations can be water vapor or ozone. When the desired aluminum containing compound is aluminum nitride, the other reactive gas in the iterations can be ammonia or a nitrogen/hydrogen plasma. When the desired aluminum containing compound is aluminum sulfide, the other reactive gas in the iterations can be hydrogen sulfide.

Likewise, if instead of aluminum compounds, silicon compounds are wanted in the coating, one of the two reactive gases can be, e.g., tetramethylsilane or silicon tetrachloride. The references incorporated above give further guidance about suitable reactive gases depending on the end result desired.

While a single iteration with the discussed reactive gases can lay down a molecular layer that may be suitable for some purposes, many useful embodiments of the method will iterate the performing step for at least 50, 100, 200 or more iterations. Each iteration adds thickness to the particles. Therefore, in some embodiments, the number of iterations is selected to achieve a predetermined particle size.

In some embodiments, the volume of the second portion 120 is at least 50 percent, or at least 60 percent, at least 75 percent, at least 85 percent, or at least 90 percent, or at least 95 percent, or at least 99 percent, or at least 99.9 percent of the volume of the particle 100. In some embodiments, the volume of the second portion 120 is in a range of 75 percent or 85 percent to 99.999 percent or to 99.9999 percent of the volume of particle 100. In some embodiments, the outer radius, R, of the second portion 120 is at least 1.5 times, 2 times, 5 times, 10 times, or 30 times the outer radius, r, of the first portion 110. In some embodiments, the outer diameter, 2 times R, of the second portion 120 is at least 1.5 times, 2 times, 5 times, 10 times, or 30 times the outer diameter, 2 times r, of the first portion 110. The particle 100 may be substantially spherical, or it may have an ellipsoidal or other shape. The radius or diameter of the particle may refer to an equivalent radius or diameter of a sphere having the same volume as the particle. In some embodiments, the outer radius, R, of the second portion 120 is in a range of 2 to 10000 times the outer radius, r, of the first portion 110. In some embodiments, the first portion 110 has a diameter (2 times r) in the range of about 1 nm to about 400 nm. In some embodiments, the particle 100 has an outer diameter (2 times R) in a range of about 100 nm to about 10 micrometers, or in a range of about 500 nm to about 10 micrometers, or in a range of about 1 micrometer to 10 micrometers.

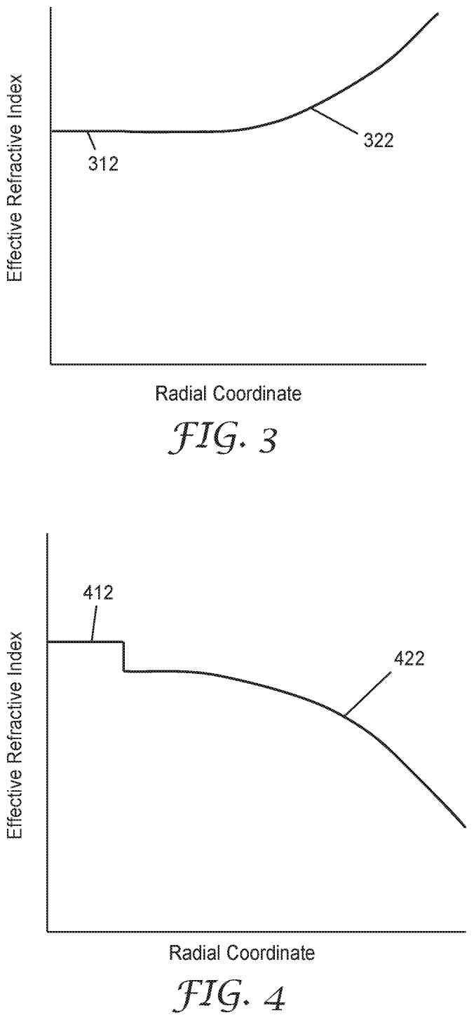

FIG. 2 is a schematic illustration of an effective refractive index of a particle as a function of radial coordinate (For example, in a spherical coordinate system (r, θ, φ), the radial coordinate is the r coordinate. For an ellipsoidal or otherwise non-spherical particle, the radial coordinate of a point may refer to the distance between the point and a center or centroid of the particle.). The effective refractive index 212 of the first portion of the particle is substantially constant and the effective refractive index 222 of the second portion of the particle is continuously varying across a thickness of the second portion. In the illustrated embodiments, the effective refractive index is not continuous from the first portion to the second portion.

An alternate embodiment is shown in FIG. 3, which is a schematic illustration of an effective refractive index of a particle as a function of radial coordinate. The effective refractive index 322 in the second portion is monotonically increasing while the effective refractive index 312 in the first portion is substantially constant. In this case, the effective refractive index is a continuous function of the radial coordinate from a center of the particle to an outer surface of the particle. The composition of the particle may also be a continuous function of the radial coordinate from the center of the particle to an outer surface of the particle.

The effective refractive index may vary at a nonzero first rate at a first position and at a nonzero second rate different from the first rate at a second position different from the first position. For example, the first position may be the position R1 depicted in FIG. 2 and the second position may be position R2 which is further from the center of the particle than position R1. In some cases, the first position may be near the center of the particle or in a portion of the second portion closest to the first portion and the second position may be near an outer surface of the particle or in a portion of the second portion closest to the outer surface of the particle. In some cases, the first and second positions are radially separated by at least 80 percent, or at least 85 percent, or at least 90 percent of the thickness of the second portion.

In some embodiments, the effective refractive index varies monotonically across the thickness of the second portion. In some embodiments, the effective refractive index monotonically increases across the thickness of the second portion and has a slope that monotonically increases across the thickness of the second portion (see, e.g., FIGS. 2-3). In some embodiments, the effective refractive index monotonically decreases across the thickness of the second portion and has a slope that monotonically decreases (becomes more negative) across the thickness of the second portion. This is illustrated in FIG. 4 which is a schematic illustration of an effective refractive index of a particle as a function of radial coordinate. The effective refractive index 422 in the second portion is monotonically decreasing while the effective refractive index 412 in the first portion is substantially constant. The slope of the effective refractive index 422 is negative with a smaller magnitude at a position in the second portion closer to the first portion and the slope is negative with a larger magnitude at a position in the second portion farther from the first portion. Particles with an effective refractive index in the second portion that has a monotonically increasing positive slope or a monotonically decreasing negative slope have been found to be particularly useful in scattering control layers, anti-sparkle films, and the like.

The rate of variation of the effective refractive index may be understood to be the magnitude of the derivative of the effective refractive index with respect to the radial coordinate. In some embodiments, an absolute value of a derivative of the effective refractive index with respect to the radial coordinate monotonically increases with increasing radial coordinate across the thickness of the second portion or monotonically increases with increasing radial coordinate across at least 80 percent, or at least 90 percent, or substantially all of the thickness of the second portion. In some embodiments, the effective refractive index varies parabolically (either increasing or decreasing) over at least a portion of the second portion and in some embodiments the effective refractive index varies parabolically (either increasing or decreasing) over all or substantially all of the second portion. For embodiments in which the effective refractive index varies parabolically, the absolute value of a derivative of the effective refractive index with respect to the radial coordinate monotonically increases linearly with the radial coordinate. In other embodiments, the absolute value of the derivative of the effective refractive index with respect to the radial coordinate may increase more slowly or more rapidly than a linear increase, or may increase more slowly in some portions of the second portion and more rapidly in other portions of the second portion compared to a linear increase.

In the embodiments illustrated in FIGS. 2-3, the effective refractive index is monotonically increasing across the thickness of the second portion, while in the embodiment illustrated in FIG. 4, the effective refractive index is monotonically decreasing across the thickness of the second portion. In other embodiments, the effective refractive index may vary non-monotonically across the thickness of the second portion. FIG. 5 is a schematic illustration of an effective refractive index of a particle as a function of radial coordinate. In this case, the effective refractive index varies non-monotonically across the thickness of the second portion. More specifically, in this case, the effective refractive index has a substantially sinusoidal variation across the thickness of the second portion.

In some embodiments, a difference between a maximum effective refractive index in the second portion and a minimum effective refractive index in the second portion is at least 0.05, or at least 0.1, or at least 0.15, or at least 0.2, and may be in a range of 0.05 to 0.8, or to 1.0, or even to 1.2. In some embodiments, the effective refractive index has a substantially sinusoidal variation across the thickness of the second portion with an amplitude of at least 0.05, or at least 0.1, or at least 0.2. In the embodiment illustrated in FIG. 5, the amplitude of the sinusoidal variation is about 0.5 (2.25-1.75).

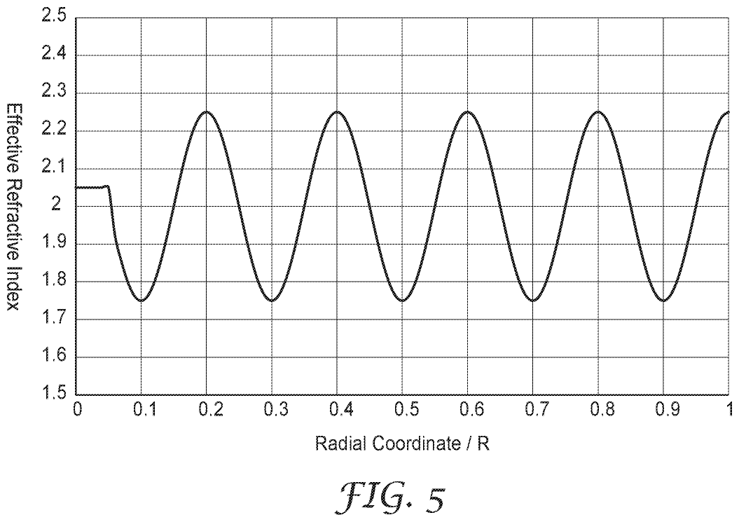

FIG. 6 is a cross-sectional view of particle 600 having first portion 610 and second portion 620 comprising a plurality of mutually concentric layers. First portion 610 may correspond to an initial particle having an outer surface 611. Second portion 620 has an outer surface 621; first, second and third layers 622, 624 and 626; and first and second transition regions 623 and 625. Particle 600 can be made utilizing ALD/MLD techniques described further elsewhere herein. The local composition and/or effective refractive index may be constant or substantially constant in the first, second and third layers 622, 624 and 626. By including the first and second transition regions 623 and 625, the local composition and/or effective refractive index may vary continuously from outer surface 611 of the initial particle to outer surface 621 of the particle 600. In some embodiments, an additional transition region is included between first portion 610 and first layer 622 so that the local composition and/or effective refractive index varies continuously from the center of the particle 600 to the outer surface 621 of the particle 600.

Each transition region may have a thickness greater than 30 nm, greater than 50 nm, or greater than 100 nm. Each transition region may have a thickness less than one half or one third or one fifth of the minimum thickness of the layers adjacent the transition region. For example, first transition region 623 may have a thickness less than ½ or ⅓ or ⅕ of the thickness of the thinner of first layer 622 and second layer 624.

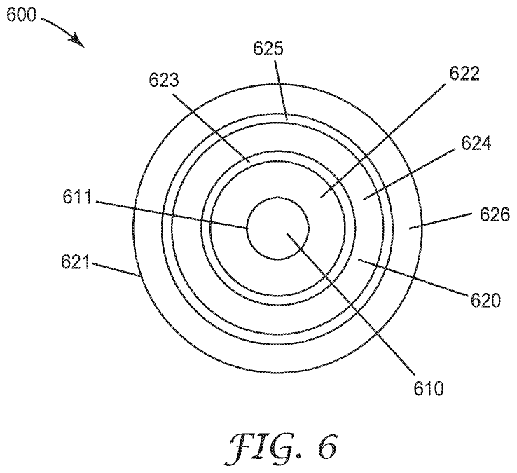

FIG. 7 shows the effective refractive index as a function of radial coordinate for a particle having an outer radius of R. The particle has a first portion, which may correspond to an initial particle, having a refractive index of 2.3 and extending from the center of the particle to a radius of about 0.1 times R. The particle includes 5 layers with refractive indices alternating between 1.6 and 2.3. Transition regions are included between each layer and between the first portion and the first layer. The effective refractive index and the local composition of the particle varies continuously from the center of the particle to an outer surface of the particle.

The refractive index may alternate from layer to layer, or some other distribution of refractive index may be used. The layers may each have the same or different thickness, the same or different volumes, or some other variation in thickness or volume of the layers may be used. In some embodiments, the layers have a thickness that alternate between thick and thin.

The number of layers of a layered particle is not particularly limited, but may vary in any suitable range. In some embodiments, the particle includes a first portion and a second portion including at least 2, or at least 3, or at least 5, or at least 10, or at least 15, or at least 20 layers and including less than 300, less than 250, less than 200, less than 150, or less than 100 layers.

In some embodiments, a composition that includes a matrix (e.g., a resin or an adhesive) and a plurality of the particles of the present description is provided. The matrix may be substantially transparent (e.g., a layer of the matrix or a layer of the composition may transmit at least 80 percent, or at least 90 percent of light in the wavelength range of 400 to 700 nm). In some embodiments, the matrix has a first refractive index similar to a second refractive index at an outer surface of the particle. For example, an absolute value of the difference between the first and second refractive indexes may be less than 0.1, or less than 0.05, or less than 0.03, or less than 0.02 or less than 0.01. In other embodiments, the matrix has a first refractive index substantially different from a second refractive index at an outer surface of the particle. In some embodiments, the matrix material is substantially excluded from the particles so that the refractive index of the particle at an outer surface of the particle is not changed by incorporating the particle into the matrix. This may occur, for example, when the particles are dispersed in a polymer layer such as a polymeric pressure sensitive adhesive. In some embodiments, the material of the matrix partially penetrates into outer portions of the particles so that the refractive index of the particle at an outer surface of the particle is shifted by the presence of the matrix material in the outer portions of the particles. In such embodiments, the refractive index difference between the outer portions of the particles and the matrix is lowered and may be substantially zero. The matrix material may partially penetrate into the particles if the matrix comprises monomers which may be subsequently cured (e.g., heat cured or radiation cured such as ultraviolet (UV) cured). The monomers may penetrate into the particles and then be cured in place when the matrix is cured. In some embodiments, an outer portion of the particles is porous and the monomers penetrate into the pores of the outer portion of the particles.

Suitable substantially transparent matrix materials include polymers, copolymers, and/or optically clear adhesives. Suitable polymers or copolymers include polyacrylates, polymethacrylates, polyolefins, polyepoxides, polyethers, and copolymers thereof. Suitable adhesives which may be used as the matrix include pressure sensitive adhesives (PSAs) and hot-melt adhesives. The matrix material may be a curable liquid, such as a UV curable acrylate.

It has been found that particles of the present description can provide various optical properties that may be useful in certain applications. For example, in some embodiments, the composition containing the particles is used to form a film or an adhesive layer or one or more layers of a film including a plurality of layers. Such film or layers may be used to provide a scattering control layer that may be used in a display application. For example, a scattering control layer including the particles described herein may be used as an anti-sparkle layer that reduces the objectionable sparkle when included in a display. Sparkle in a display can be described as a grainy pattern that appears to move around or flicker with small changes in the position of the viewer relative to the display. Sparkle in a display can be caused by light from a pixel interacting with a non-uniformity in the optical path of the light, typically on the surface of a display. Light from a pixel may appear to move around or flicker as the viewer moves due to the interaction of the pixel light with the non-uniformity. Such non-uniformities can include structure or surface texture from a film or other layer that might be added to a display. For example, surface texture in anti-glare films is often included in order to reduce specular reflection from the surface thereby reducing glare. Non-uniformities that can generate sparkle also include fingerprints, scratches or other residue on the display surface. In some embodiments, the particles included in a scattering control layer or an anti-sparkle film are selected to give controlled diffraction, refraction or a combination thereof and when incorporated into a display can significantly reduce sparkle while substantially maintaining the perceived display resolution.

In some embodiments, a layer including particles of the present description may include other particles having other functionalities such as, for example, nanoparticles or nano-wires. In some embodiments, a hard coat layer may contain particles of the present description in an acrylate binder or matrix along with inorganic nanoparticles to increase the hardness of the layer. In some embodiments, the particles of the present description may be included in a material that is extruded to form an optical film or one or more layers in an optical film. In some embodiments, the particles of the present description may be included in an injection molded part by including the particles in a resin that is used to form the injection molded part.

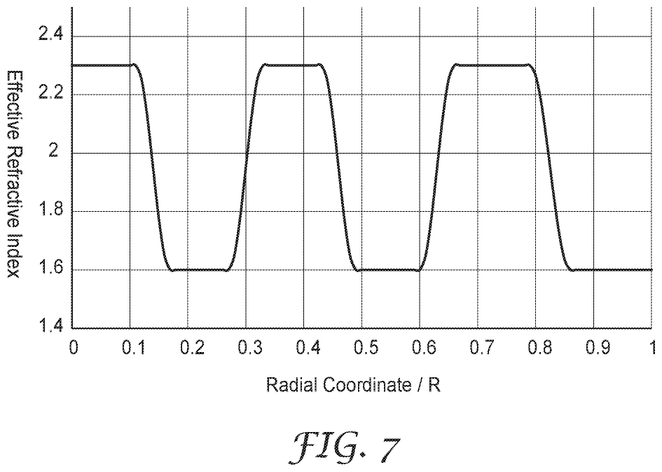

FIG. 8 is a cross-sectional view of layer 801, which may be a scattering control layer that may be suitable for use as an anti-sparkle film or as a layer in an anti-sparkle film. Layer 801 includes a plurality of particles 800 which may correspond to any of the particles described herein. For example, in some embodiments, particles 800 have an effective refractive index that monotonically increases across the thickness of the second portion and that has a slope which monotonically increases across the thickness of the second portion, or have an effective refractive index that monotonically decreases across the thickness of the second portion and that has a slope which monotonically decreases across the thickness of the second portion. A collimated beam of light 840 is schematically illustrated in FIG. 8. When collimated beam of light 840 passes through layer 801 an output distribution 842 of light is produced. In some embodiments, when the collimated beam of light 840 passes through the layer 801 (or through an anti-sparkle film including layer 801), more than about 30 percent of the collimated light beam is scattered by between 2 and 10 degrees measured in air, and less than 30 percent of the collimated light beam is scattered by more than 10 degrees measured in air. In some embodiments, when the collimated beam of light 840 passes through the layer 801 (or through an anti-sparkle film including layer 801), a light output distribution includes a central lobe region, a ring region, and a low intensity region separating the central lobe region and the ring region. Layer 801 may be said to provide controlled diffraction, refraction or a combination or diffraction and refraction.

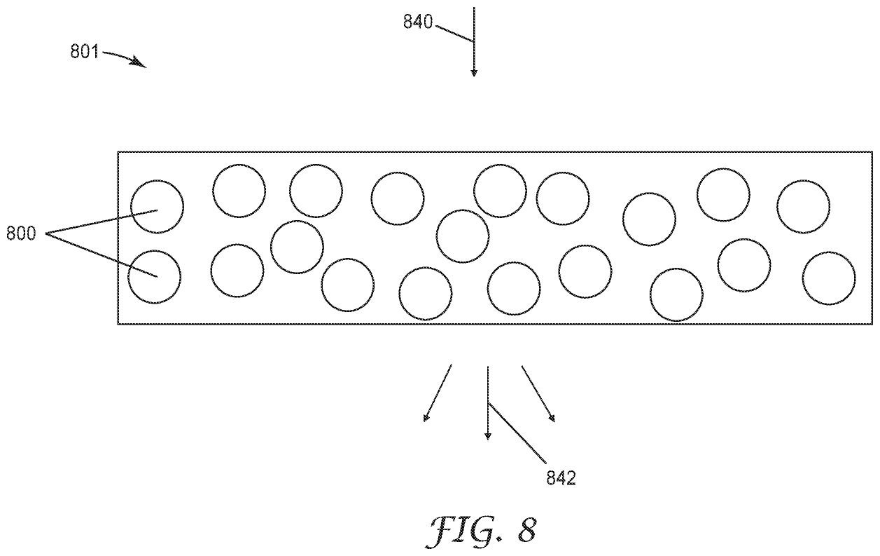

A light output distribution that could be generated when the collimated beam of light 840 passes through the layer 801 (or through an anti-sparkle film including layer 801) is schematically illustrated in FIG. 9 which shows a plot of the output distribution as a function of scattering angle. The output distribution includes a central lobe region 972 having a first maximum intensity of I₁ and includes a ring region 974 having a second maximum intensity of I₂. In FIG. 9, a cross-section of ring region 974 appears as two peaks at the sides of the plot. The region 976 between the central lobe region 972 and the ring region 974 may have an intensity less than one half of I₁ and less than one half of I₂. In some embodiments, at least some portions of the region 976 between the central lobe region 972 and the ring region 974 may have an intensity less than 0.1 times I₁ and less than 0.1 times I₂. In some embodiments, I₂ divided by I₁ is in a range of about 0.05 to about 1.0. The difference in scattering angle between the location of the maximum intensity I₂ in the ring region 974 and the location of the maximum intensity I₁ in the central lobe region 972 may be greater than 1 degree, or greater than 2 degrees, or greater than 3 degrees and may be less than 30 degrees, or less than 25 degrees, or less than 20 degrees. The location of the maximum intensity I₁ in the central lobe region 972 may be at a scattering angle having a magnitude of less than 1 degree or may be at a substantially zero scattering angle.

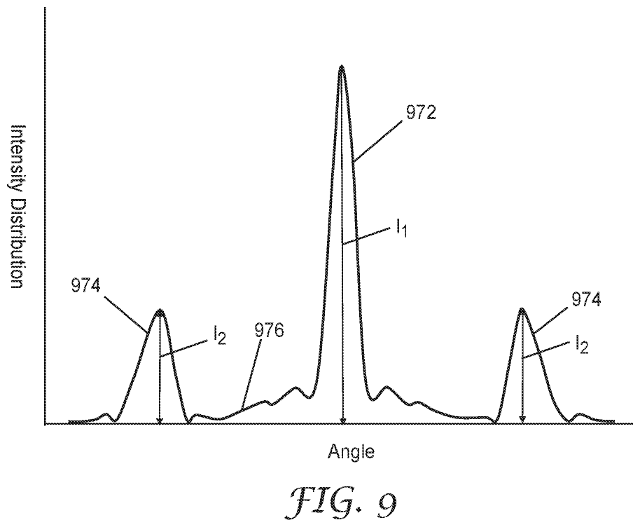

In some embodiments, a multilayer film is provided where at least one layer of the multilayer film is a composition that includes particles according to the present description. An example is illustrated in FIG. 10 which shows a multilayer film 1002 having three layers including layer 1001, which may correspond to layer 801, for example. Multilayer film further includes layer 1052, which may be a hard coat layer, for example, and layer 1054, which may be an adhesive layer for example. The hard coat layer may be formed from a resin that when cured is hard enough to provide adequate pencil hardness or abrasion resistance in applications where the material can be an outer layer. For example, the cured hard coat resin may provide a pencil hardness greater than HB or greater than H. Suitable hard coat resins include acrylic resins that may include inorganic nanoparticles. Suitable adhesive layers, which may be optically clear adhesive layers, include pressure sensitive adhesives (PSAs) and hot-melt adhesives. Useful adhesives that may be used in layer 1054 and/or that may be used as the matrix in layer 1001 include elastomeric polyurethane or silicone adhesives and the viscoelastic optically clear adhesives CEF22, 817x, and 818x, all available from 3M Company, St. Paul, Minn. Other useful adhesives include PSAs based on styrene block copolymers, (meth)acrylic block copolymers, polyvinyl ethers, polyolefins, and poly(meth)acrylates. Multilayer film 1002 may be used as an anti-sparkle film that can be adhered to an outer surface of a display.

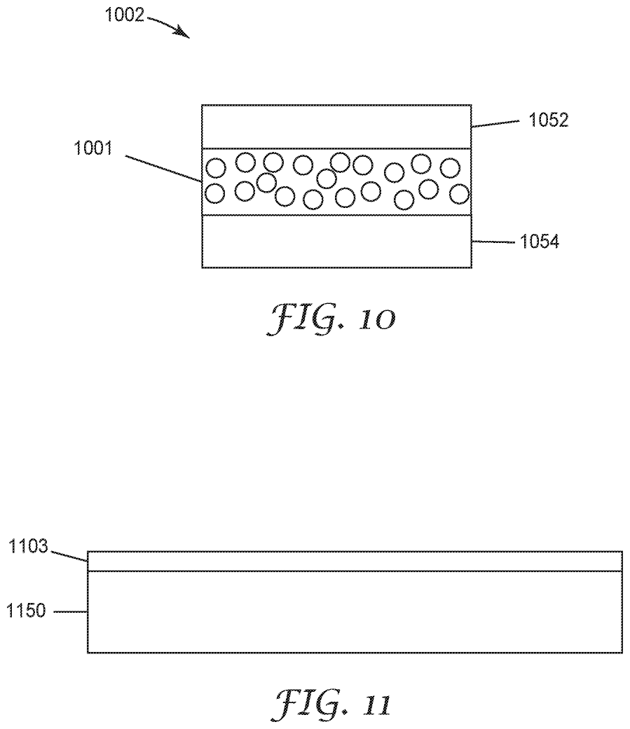

FIG. 11 schematically illustrates film or layer 1103 disposed on a display 1150. Film or layer 1103 may correspond to layer 801 or multilayer film 1002, for example. Film or layer 1103 may be a scattering control layer or an anti-sparkle film, for example.

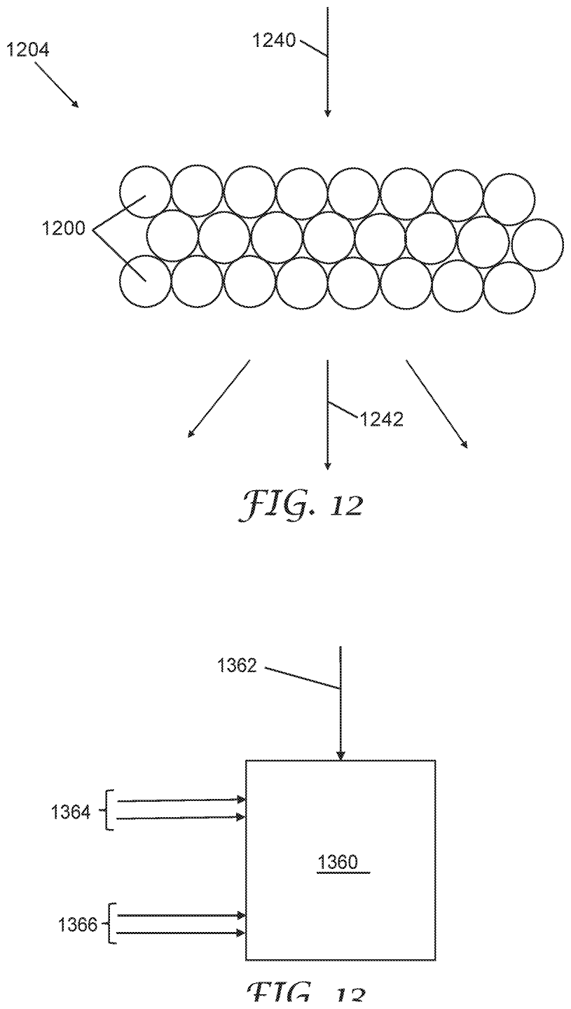

In some aspect of the present description, one or more ordered layers of the particles described herein is provided. The total number of layers may be, for example in a range of 1 to 3. Using only a few layers (e.g., one, two or three layers) allows the optical effects of individual particles to be retained. FIG. 12 shows one or more ordered layers 1204 which includes particles 1200 arranged into three ordered layers. One or more ordered layers 1204 can be prepared via solution deposition onto a substrate, for example. A collimated beam of light 1240 is schematically illustrated in FIG. 12. When collimated beam of light 1240 passes through one or more ordered layers 1204 an output distribution of light 1242 is produced. In some embodiments, when the collimated beam of light 1240 passes through the one or more ordered layers 1204 of particles 1200, more than about 30 percent of the collimated light beam is scattered by between 2 and 10 degrees measured in air, and less than 30 percent of the collimated light beam is scattered by more than 10 degrees measured in air. In some embodiments, when the collimated beam of light 1240 passes through one or more ordered layers 1204, a light output distribution includes a central lobe region, a ring region, and a low intensity region separating the central lobe region and the ring region as shown schematically in FIG. 9. In some embodiments, the region between the central lobe region and the ring region may have an intensity less than one half of the first maximum intensity I₁ of the lobe region and less than one half of the second maximum intensity I₂ of the ring region. In some embodiments, at least some portions of the region between the central lobe and the ring region may have an intensity less than 0.1 times I₁ and less than 0.1 times I₂. In some embodiments, the second maximum intensity divided by the first maximum intensity is in a range of about 0.05 to about 1.0. In some embodiments, the difference in scattering angle between the location of the maximum intensity I₂ in the ring region and the location of the maximum intensity I₁ in the central lobe region may be greater than 1 degree, or greater than 2 degrees, or greater than 3 degrees and may be less than 30 degrees, or less than 25 degrees, or less than 20 degrees. One or more ordered layers 1204 may be said to provide controlled diffraction, refraction or a combination or diffraction and refraction.

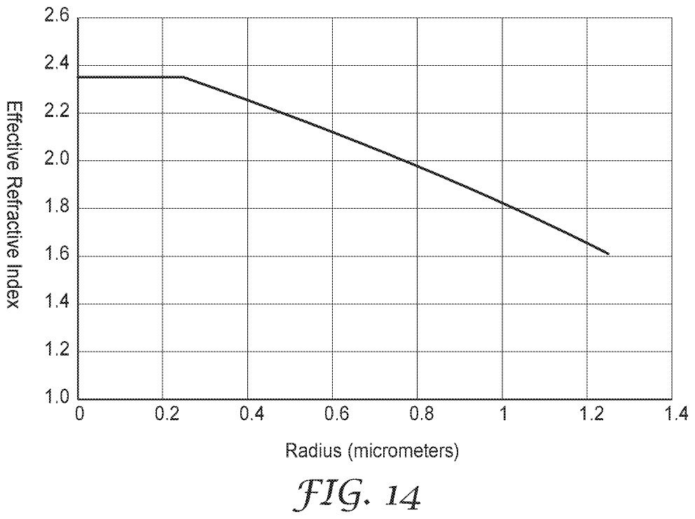

FIG. 13 is a schematic illustration of a reactor 1360 for making particles according to the present description. The reactor 1360 is initially charged with one or more initial particles 1362 which may be in a solution and which may correspond to the first portion of the grown particles. Precursors are provided to the initial particles 1362 through precursor supply lines 1364 and oxidizer is supplied through oxidizer supply lines 1366. The precursors may include first and second metal oxides, for example, and/or may also include at least one organic precursors. Reactor 1360 may be a vacuum rotary-tumbler type reactor equipped with a gas inlet port and porous sidewalls to be used as the gas exit. In some embodiments, the reactor 1360 is a fluidized bed reactor and the particles are grown using atomic and/or molecular layer deposition in liquid phase. The reactor 1360 may be used to grow a particle from an initial particle 1362 until the particle has an outer diameter at least twice the diameter of the initial particle 1362 (first portion). The size of the first portions and the size of the particles after the reaction has completed may be in any of the ranges described elsewhere herein. For example, the final particle size may be at least 2 times, or at least 5 times, or at least 10 times the diameter of the initial particle. The second portion of the particle, which is grown around the initial particle, has an effective refractive index that varies substantially continuously across the thickness of the second portion and/or has a local composition that varies substantially continuously across a thickness of the second portion, as described further elsewhere herein.

The following is a list of exemplary embodiments of the present description.

Embodiment 1 is a particle having a first portion and a second portion surrounding the first portion, wherein a volume of the second portion is at least 50 percent of a volume of the particle, the second portion comprises a material having a composition that varies across a thickness of the second portion and an effective refractive index that varies substantially continuously across the thickness of the second portion, and the material comprises a plurality of inorganic regions.
Embodiment 2 is the particle of Embodiment 1, wherein the effective refractive index at a position in the second portion of the particle is a refractive index of a composition of materials present in the second portion within 20 nm of the position.
Embodiment 3 is the particle of Embodiment 1, wherein the effective refractive index at a position in the second portion of the particle is a refractive index of a composition of materials present in the second portion within 50 nm of the position.
Embodiment 4 is the particle of Embodiment 1, wherein a first region in the plurality of inorganic regions comprises a first inorganic component and a different second region in the plurality of inorganic regions comprises a different second inorganic component.
Embodiment 5 is the particle of Embodiment 4, wherein the first inorganic component is a first metal oxide and the second inorganic component is a second metal oxide.
Embodiment 6 is the particle of Embodiment 1, wherein the plurality of inorganic regions comprises at least one metal oxide.
Embodiment 7 is the particle of Embodiment 1, wherein the material further comprises at least one organic region.
Embodiment 8 is the particle of Embodiment 1, wherein the effective refractive index varies monotonically across the thickness of the second portion.
Embodiment 9 is the particle of Embodiment 7, wherein the effective refractive index monotonically increases across the thickness of the second portion and has a slope that monotonically increases across the thickness of the second portion.
Embodiment 10 is the particle of Embodiment 7, wherein the effective refractive index monotonically decreases across the thickness of the second portion and has a slope that monotonically decreases across the thickness of the second portion.
Embodiment 11 is the particle of Embodiment 1, wherein the effective refractive index varies non-monotonically across the thickness of the second portion.
Embodiment 12 is the particle of Embodiment 11, wherein the effective refractive index varies sinusoidally across the thickness of the second portion.
Embodiment 13 is the particle of Embodiment 1, wherein a difference between a maximum effective refractive index in the second portion and a minimum effective refractive index in the second portion is at least 0.05.
Embodiment 14 is the particle of Embodiment 1, wherein the volume of the second portion is at least 85 percent of the volume of the particle.
Embodiment 15 is the particle of Embodiment 1, wherein the second portion comprises a plurality of mutually concentric layers with transition regions between adjacent concentric layers, each concentric layer having a substantially constant refractive index, wherein adjacent concentric layers have different refractive indices and the transition regions between adjacent concentric layers have a thickness less than about ⅓ of a minimum thickness of the immediately adjacent concentric layers.
Embodiment 16 is the particle of Embodiment 1 having an outer diameter in a range of 100 nm to 10 micrometers.
Embodiment 17 is a particle having a first portion and a second portion surrounding the first portion, wherein a volume of the second portion is at least 50 percent of a volume of the particle, the second portion comprises a material having a local composition that varies substantially continuously across a thickness of the second portion, and the material comprises a plurality of inorganic regions.
Embodiment 18 is the particle of Embodiment 17, wherein the local composition at a position in the second portion of the particle is a composition of materials present in the second portion within 20 nm of the position.
Embodiment 19 is the particle of Embodiment 17, wherein the local composition at a position in the second portion of the particle is a composition of materials present in the second portion within 50 nm of the position.
Embodiment 20 is the particle of Embodiment 17, wherein a first region in the plurality of inorganic regions comprises a first inorganic component and a different second region in the plurality of inorganic regions comprises a different second inorganic component.
Embodiment 21 is the particle of Embodiment 20, wherein the first inorganic component is a first metal oxide and the second inorganic component is a second metal oxide.
Embodiment 22 is the particle of Embodiment 17, wherein the plurality of inorganic regions comprises at least one metal oxide.
Embodiment 23 is the particle of Embodiment 17, wherein the material further comprises at least one organic region.
Embodiment 24 is one or more ordered layers of the particles of any of Embodiment 1 to 23.
Embodiment 25 is the one or more ordered layers of Embodiment 24, wherein a total number of the ordered layers is in a range of 1 to 3.
Embodiment 26 is a mixture comprising:
a substantially transparent matrix having a first refractive index; and
a plurality of the particles of any of Embodiments 1 to 23 dispersed in the matrix.
Embodiment 27 is a scattering control layer comprising the mixture of Embodiment 26, wherein when a collimated beam of light passes through the scattering control layer, a light output distribution comprises a central lobe region, a ring region, and a low intensity region separating the central lobe region and the ring region.
Embodiment 28 is an anti-sparkle film comprising the scattering control layer of Embodiment 27.
Embodiment 29 is a method of making a particle having a first portion and a second portion surrounding the first portion, the method comprising:
providing the first portion; and
growing the particle from the first portion by atomic or molecular layer deposition of a material onto a surface of the growing particle until the particle has an outer diameter at least twice a diameter of the first portion,
wherein the material has a composition that varies across a thickness of the second portion and an effective refractive index that varies substantially continuously across the thickness of the second portion.
Embodiment 30 is a method of making a particle having a first portion and a second portion surrounding the first portion, the method comprising:
providing the first portion; and
growing the particle from the first portion by atomic or molecular layer deposition of a material onto a surface of the growing particle until the particle has an outer diameter at least twice a diameter of the first portion,
wherein the material has a local composition that varies substantially continuously across a thickness of the second portion.
Embodiment 31 is the method of Embodiment 29 or 30, wherein the material comprises a plurality of inorganic regions.
Embodiment 32 is the method of Embodiment 29 or 30, wherein a first region in the plurality of inorganic regions comprises a first inorganic component and a different second region in the plurality of inorganic regions comprises a different second inorganic component.
Embodiment 33 is the method of Embodiment 32, wherein the first inorganic component is a first metal oxide and the second inorganic component is a second metal oxide.
Embodiment 34 is the method of Embodiment 31, wherein the material further comprises a plurality of organic regions.
Embodiment 35 is the method of Embodiment 29 or 30, wherein the material comprises a plurality of organic regions.
Embodiment 36 is the method of Embodiment 29 or 30, wherein growing the particle comprises depositing the material via atomic layer deposition.
Embodiment 37 is the method of Embodiment 29 or 30, wherein growing the particle comprises depositing the material via molecular layer deposition.
Embodiment 38 is the method of Embodiment 29 or 30, wherein growing the particle comprises depositing the material via alternating steps of atomic layer deposition and molecular layer deposition.
Embodiment 39 is the method of Embodiment 38, wherein an inorganic material is deposited in the atomic layer deposition steps and an organic material is deposited in the molecular layer deposition steps.
Embodiment 40 is the method of Embodiment 29 or 30, wherein the atomic or molecular layer deposition occurs in gas phase.
Embodiment 41 is the method of Embodiment 29 or 30, wherein the atomic or molecular layer deposition occurs in liquid phase.

### EXAMPLES

### Example 1

Particles are grown in an ALD process from starting TiO₂ particles having a radius of 500 nm. The starting particles correspond to first portion 110 and the particles are grown to a diameter of 2.5 micrometers. The organometallic precursors trimethylaluminum (TMA) and titanium (IV) isoproxide (TTIP) are used to deposit Al₂O₃ and TiO₂ respectively. Oxygen plasma and/or water is used as the oxidizer.

The starting TiO₂ core particles are loaded into a vacuum rotary-tumbler type reactor equipped with a gas inlet port and porous sidewalls to be used as the gas exit. The system also contains two organometallic precursor supply lines and two oxidizer supply lines. One of the oxidizer supply lines is also equipped with a radio frequency plasma generator with the appropriate gas supply lines.

Once the particles have been added to the rotary-tumbler reactor, it is closed and pumped down to a pressure of 1 torr with the carrier gas flowing through the inlet port and through the particles. The carrier gas then exits through the porous sidewalls of the rotary-tumbler reactor while keeping the TiO₂ core particles free flowing inside the reactor.

The reactor system and the 500 nm TiO₂ particles are then heated up to the ALD process temperature recommended for the precursors being used, with the carrier gas still flowing. The carrier gas remains flowing during the entire coating process to assist in preventing agglomeration of the growing particles.

After heating the rotary-tumbler type reactor system to the appropriate temperature the system is then flushed with carrier gas for one hour to stabilize and assure that the particles are at temperature and free of any residual moisture or gases.

Prior to the starting the actual charging of the precursors into the rotary-tumbler type reactor a sequencing program is generated as outlined in Tables 1-4 to determine the ratio of the precursors and oxidizing agents needed to generate the desired effective refractive index gradient. The sequence is divided into 82 sections with each section adding a layer of thickness of 12.195 nm to the particle. The sections are divided into subsections with the number of TiO₂ cycles and Al₂O₃ cycles needed to give the 12.195 nm layer thickness with the desired volume and weight fraction of TiO₂ and Al₂O₃. Each TiO₂ cycle deposits about 0.026 nm and each Al₂O₃ cycle deposits about 0.15 nm. The cycles of each section are interspersed approximately uniformly with each other to provide a substantially continuous effective refractive index. For example, section 5 includes 446 TiO₂ cycles and 4 Al₂O₃ cycles which are deposited using, in sequence, 112 TiO₂ cycles, 1 Al₂O₃ cycle, 111 TiO₂ cycles, 1 Al₂O₃ cycle, 112 TiO₂ cycles, 1 Al₂O₃ cycle, 111 TiO₂ cycles, and 1 Al₂O₃ cycle. The charging sequence of the precursors is written into the precursor control program for each of the subsections to assure that the correct refractive index gradient is achieved.

After it is verified that all reactor sections are at the correct set points for temperature, gas flow rates and pressure, the precursor charging sequence is initiated and let run until completion. The precursor charging sequence includes the continuous flowing of the carrier gas, the charging of the organometallic precursor to saturate the particle surface, a purging step to remove any excess organometallic precursor and byproduct gasses, the charging of the oxidizing precursor to react with all of the available organometallic precursor on the surface of the particle followed by another purging step to remove any excess oxidizing precursor and byproduct gasses. The order and sequence of which organometallic and what oxidizer for each cycle follows the sequencing program outlined in Tables 1-4.

The organometallic precursor enters into the reactor through an inlet in the end of the tumbler along with the carrier gas flow. The precursor then saturates the surface of the particle generating a byproduct gas such as methane or isopropyl alcohol and the gases exit the reactor through the porous sidewalls of the rotary-tumbler reactor.

The system is then purged for a given amount of time to assure that all free precursor and byproduct gases have been removed from the rotary-tumbler reactor. Once the purging is complete, the oxidizing precursor is then added to the reactor and allowed to saturate/oxidize the surface of the particle. The oxidizer and all other gases exits the reactor through the porous sidewalls of the rotary-tumbler reactor.

The system is then again purged for a given amount of time to assure that all free precursor and byproduct gases have been removed from the rotary-tumbler reactor.

This sequence is then repeated following the predetermined sequencing program with the appropriate organometallic precursors and appropriate oxidizing precursors being used for each section. At the completion of the sequence, the second portion of the particle has the desired thickness and the desired effective refractive index variation across the thickness of the second portion.

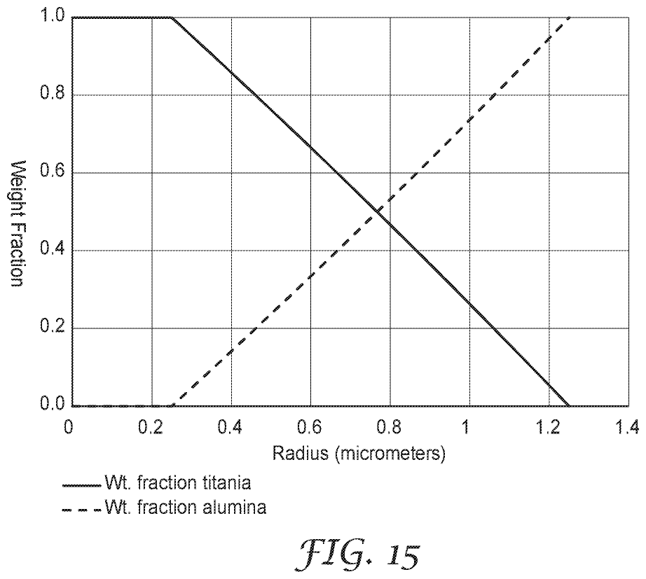

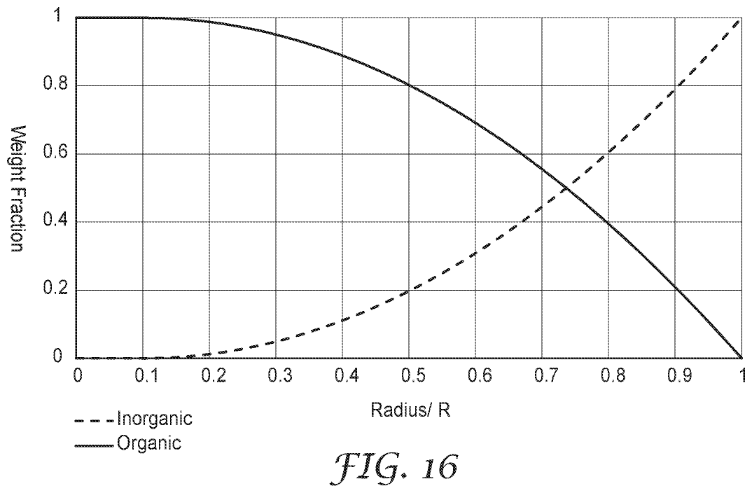

Tables 1-4 give the number of TiO₂ and Al₂O₃ cycles for each section. From the known thickness per cycle, the volume fractions of each of TiO₂ and Al₂O₃ in the section is determined from the thickness ratios and the effective refractive index is determined as the square root of the volume weighted average of the refractive index squared of the individual TiO₂ and Al₂O₃ components. The resulting effective refractive index is shown in FIG. 14. The weight fractions of TiO₂ and Al₂O₃ in the section are determined from the deposited thickness and the densities (4.23 g/cm³ for TiO₂ and 3.95 g/cm³ for Al₂O₃) and are shown in FIG. 15.

TABLE 1

| | TiO₂ | Al₂O₃ | Wt. Frac. | Wt. Frac. | Eff. Refract. |
|---|---|---|---|---|---|
| Section | Cycles | Cycles | TiO₂ | Al₂O₃ | Index |
| 1 | 469 | 0 | 1.000 | 0.000 | 2.350 |
| 2 | 463 | 1 | 0.989 | 0.011 | 2.342 |
| 3 | 458 | 2 | 0.977 | 0.023 | 2.335 |
| 4 | 452 | 3 | 0.966 | 0.034 | 2.327 |
| 5 | 446 | 4 | 0.954 | 0.046 | 2.319 |
| 6 | 440 | 5 | 0.943 | 0.057 | 2.312 |
| 7 | 435 | 6 | 0.931 | 0.069 | 2.304 |
| 8 | 429 | 7 | 0.920 | 0.080 | 2.296 |
| 9 | 423 | 8 | 0.908 | 0.092 | 2.288 |
| 10 | 418 | 9 | 0.897 | 0.103 | 2.281 |
| 11 | 412 | 10 | 0.885 | 0.115 | 2.273 |
| 12 | 406 | 11 | 0.874 | 0.126 | 2.265 |
| 13 | 400 | 12 | 0.862 | 0.138 | 2.257 |
| 14 | 395 | 13 | 0.850 | 0.150 | 2.249 |
| 15 | 389 | 14 | 0.839 | 0.161 | 2.241 |
| 16 | 383 | 15 | 0.827 | 0.173 | 2.233 |
| 17 | 378 | 16 | 0.815 | 0.185 | 2.225 |
| 18 | 372 | 17 | 0.804 | 0.196 | 2.217 |
| 19 | 366 | 18 | 0.792 | 0.208 | 2.209 |
| 20 | 360 | 19 | 0.780 | 0.220 | 2.201 |

TABLE 2

| | TiO₂ | Al₂O₃ | Wt. Frac. | Wt. Frac. | Eff. Refract. |
|---|---|---|---|---|---|
| Section | Cycles | Cycles | TiO₂ | Al₂O₃ | Index |
| 21 | 355 | 20 | 0.769 | 0.231 | 2.193 |
| 22 | 349 | 21 | 0.757 | 0.243 | 2.185 |
| 23 | 343 | 22 | 0.745 | 0.255 | 2.176 |
| 24 | 337 | 23 | 0.733 | 0.267 | 2.168 |
| 25 | 332 | 24 | 0.721 | 0.279 | 2.160 |
| 26 | 326 | 25 | 0.709 | 0.291 | 2.152 |
| 27 | 320 | 26 | 0.698 | 0.302 | 2.143 |
| 28 | 315 | 27 | 0.686 | 0.314 | 2.135 |
| 29 | 309 | 28 | 0.674 | 0.326 | 2.126 |
| 30 | 303 | 29 | 0.662 | 0.338 | 2.118 |
| 31 | 297 | 30 | 0.650 | 0.350 | 2.110 |
| 32 | 292 | 31 | 0.638 | 0.362 | 2.101 |
| 33 | 286 | 32 | 0.626 | 0.374 | 2.093 |
| 34 | 280 | 33 | 0.614 | 0.386 | 2.084 |
| 35 | 275 | 34 | 0.602 | 0.398 | 2.075 |
| 36 | 269 | 35 | 0.590 | 0.410 | 2.067 |
| 37 | 263 | 36 | 0.578 | 0.422 | 2.058 |
| 38 | 257 | 37 | 0.566 | 0.434 | 2.049 |
| 39 | 252 | 38 | 0.554 | 0.446 | 2.041 |
| 40 | 246 | 39 | 0.541 | 0.459 | 2.032 |
| 41 | 240 | 40 | 0.529 | 0.471 | 2.023 |

TABLE 3

| | TiO₂ | Al₂O₃ | Wt. Frac. | Wt. Frac. | Eff. Refract. |
|---|---|---|---|---|---|
| Section | Cycles | Cycles | TiO₂ | Al₂O₃ | Index |
| 42 | 235 | 41 | 0.517 | 0.483 | 2.014 |
| 43 | 229 | 42 | 0.505 | 0.495 | 2.005 |
| 44 | 223 | 43 | 0.493 | 0.507 | 1.996 |
| 45 | 217 | 44 | 0.480 | 0.520 | 1.987 |
| 46 | 212 | 45 | 0.468 | 0.532 | 1.978 |
| 47 | 206 | 46 | 0.456 | 0.544 | 1.969 |
| 48 | 200 | 47 | 0.444 | 0.556 | 1.960 |
| 49 | 194 | 48 | 0.431 | 0.569 | 1.951 |
| 50 | 189 | 49 | 0.419 | 0.581 | 1.942 |
| 51 | 183 | 50 | 0.407 | 0.593 | 1.933 |
| 52 | 177 | 51 | 0.394 | 0.606 | 1.924 |
| 53 | 172 | 52 | 0.382 | 0.618 | 1.914 |
| 54 | 166 | 53 | 0.369 | 0.631 | 1.905 |
| 55 | 160 | 54 | 0.357 | 0.643 | 1.895 |
| 56 | 154 | 55 | 0.345 | 0.655 | 1.886 |
| 57 | 149 | 56 | 0.332 | 0.668 | 1.877 |
| 58 | 143 | 57 | 0.320 | 0.680 | 1.867 |
| 59 | 137 | 58 | 0.307 | 0.693 | 1.857 |
| 60 | 132 | 58 | 0.295 | 0.705 | 1.848 |
| 61 | 126 | 59 | 0.282 | 0.718 | 1.838 |
| 62 | 120 | 60 | 0.269 | 0.731 | 1.828 |

TABLE 4

| | TiO₂ | Al₂O₃ | Wt. Frac. | Wt. Frac. | Eff. Refract. |
|---|---|---|---|---|---|
| Section | Cycles | Cycles | TiO₂ | Al₂O₃ | Index |
| 63 | 114 | 61 | 0.257 | 0.743 | 1.818 |
| 64 | 109 | 62 | 0.244 | 0.756 | 1.809 |
| 65 | 103 | 63 | 0.231 | 0.769 | 1.799 |
| 66 | 97 | 64 | 0.219 | 0.781 | 1.789 |
| 67 | 92 | 65 | 0.206 | 0.794 | 1.779 |
| 68 | 86 | 66 | 0.193 | 0.807 | 1.769 |
| 69 | 80 | 67 | 0.181 | 0.819 | 1.759 |
| 70 | 74 | 68 | 0.168 | 0.832 | 1.748 |
| 71 | 69 | 69 | 0.155 | 0.845 | 1.738 |
| 72 | 63 | 70 | 0.142 | 0.858 | 1.728 |
| 73 | 57 | 71 | 0.129 | 0.871 | 1.717 |
| 74 | 51 | 72 | 0.117 | 0.883 | 1.707 |
| 75 | 46 | 73 | 0.104 | 0.896 | 1.696 |
| 76 | 40 | 74 | 0.091 | 0.909 | 1.686 |
| 77 | 34 | 75 | 0.078 | 0.922 | 1.675 |
| 78 | 29 | 76 | 0.065 | 0.935 | 1.665 |
| 79 | 23 | 77 | 0.052 | 0.948 | 1.654 |
| 80 | 17 | 78 | 0.039 | 0.961 | 1.643 |
| 81 | 11 | 79 | 0.026 | 0.974 | 1.632 |
| 82 | 6 | 80 | 0.013 | 0.987 | 1.621 |
| 83 | 0 | 81 | 0.000 | 1.000 | 1.610 |

### Example 2

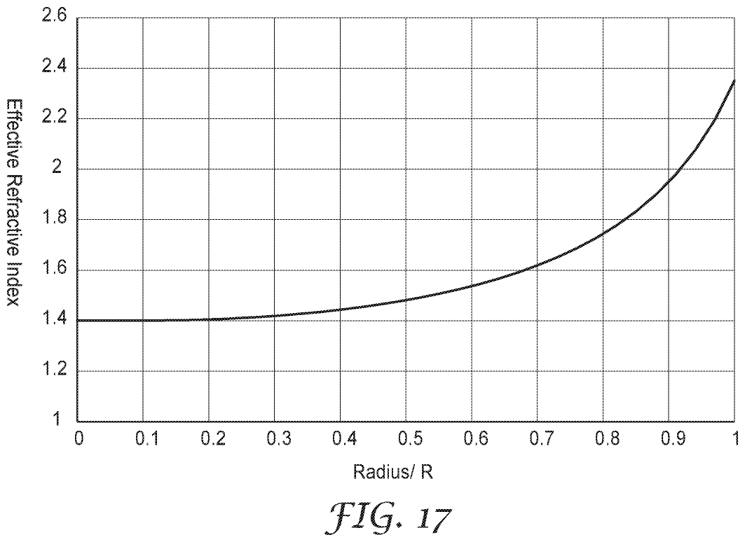

Particles are grown in a manner similar to Example 1, except that molecular layer deposition is used to deposit the low index component. TiO₂ is deposited using the organometallic precursor TTIP using atomic layer deposition as in Example 1. The organic precursor for the low index component may be an organic diol or polyol, for example, such as ethylene glycol, hexadiyne diol or hydroquinone diol. For the purpose of this Example, the low index material deposited via MLD is taken to be an organic material characterized by a density of 1.2 g/cm³ and a refractive index of 1.4. The particle is grown in sections as in Example 1 with the steps in the section selected to give a desired weight fraction distribution. FIG. 16 is a plot of this weight fraction distribution of the inorganic and the organic materials as a function of radius divided by the outer radius R of the particle. The initial particle is taken to be made from the same organic material that is deposited onto the growing particle. The radius of the inner particle is 0.1 times the outer radius of the grown particle. The outer radius of the grown particle may be 500 nm (outer diameter of 1 micrometer), in which case the inner radius is 50 nm (inner diameter of 100 nm). From the weight fraction distribution and the known densities, the volume fractions of each of the components are determined and the effective refractive index is determined as the square root of the volume weighted average of the refractive index squared of the individual components. FIG. 17 is a plot of the effective refractive index of the particle as a function of radius divided by the outer radius R of the particle. The effective refractive index monotonically increases, with a monotonically increasing slope, across the thickness of the second portion of the particle.

An alternative particle can be grown by starting with TiO₂ particles as the initial particles and using a combination of ALD and MLD with the weight fractions shown in FIG. 16 reversed so that the resulting particles have an effective refractive index that is equal to 2.35 in the first portion and which monotonically decreases, with a monotonically decreasing slope, to 1.4 at an outer surface of the second portion.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A particle having a first portion and a second portion surrounding the first portion, wherein a volume of the second portion is at least 50 percent of a volume of the particle, the second portion comprises a material having a composition that varies across a thickness of the second portion and an effective refractive index that varies substantially continuously across the thickness of the second portion, and the material comprises a plurality of inorganic regions.

2. The particle of claim 1, wherein the effective refractive index at a position in the second portion of the particle is a refractive index of a composition of materials present in the second portion within 20 nm of the position.

3. The particle of claim 1, wherein a first region in the plurality of inorganic regions comprises a first inorganic component and a different second region in the plurality of inorganic regions comprises a different second inorganic component.

4. The particle of claim 1, wherein the material further comprises at least one organic region.

5. The particle of claim 1, wherein the effective refractive index varies monotonically across the thickness of the second portion.

6. The particle of claim 1, wherein the effective refractive index varies non-monotonically across the thickness of the second portion.

7. The particle of claim 1, wherein the second portion comprises a plurality of mutually concentric layers with transition regions between adjacent concentric layers, each concentric layer having a substantially constant refractive index, wherein adjacent concentric layers have different refractive indices and the transition regions between adjacent concentric layers have a thickness less than about ⅓ of a minimum thickness of the immediately adjacent concentric layers.

8. A particle having a first portion and a second portion surrounding the first portion, wherein a volume of the second portion is at least 50 percent of a volume of the particle, the second portion comprises a material having a local composition that varies substantially continuously across a thickness of the second portion, and the material comprises a plurality of inorganic regions.

9. The particle of claim 8, wherein the local composition at a position in the second portion of the particle is a composition of materials present in the second portion within 20 nm of the position.

10. The particle of claim 8, wherein a first region in the plurality of inorganic regions comprises a first inorganic component and a different second region in the plurality of inorganic regions comprises a different second inorganic component.

11. The particle of claim 8, wherein the material further comprises at least one organic region.

12. One or more ordered layers of the particles of claim 1.

13. A mixture comprising:
a substantially transparent matrix having a first refractive index; and
a plurality of the particles of claim 1 dispersed in the matrix.

14. A scattering control layer comprising the mixture of claim 13, wherein when a collimated beam of light passes through the scattering control layer, a light output distribution comprises a central lobe region, a ring region, and a low intensity region separating the central lobe region and the ring region.

15. (canceled)

16. A method of making a particle having a first portion and a second portion surrounding the first portion, the method comprising:
providing the first portion; and
growing the particle from the first portion by atomic or molecular layer deposition of a material onto a surface of the growing particle until the particle has an outer diameter at least twice a diameter of the first portion,
wherein the material has a local composition that varies substantially continuously across a thickness of the second portion.

17. The method of claim 16, wherein growing the particle comprises depositing the material via atomic layer deposition.

18. The method of claim 16, wherein growing the particle comprises depositing the material via molecular layer deposition.

19. The method of claim 16, wherein growing the particle comprises depositing the material via alternating steps of atomic layer deposition and molecular layer deposition.

20. The particle of claim 1, wherein the volume of the second portion is at least 85 percent of the volume of the particle.

21. The particle of claim 8, wherein the volume of the second portion is at least 85 percent of the volume of the particle.
